(19) United States
(12) Patent Application Publication
(10) Pub. No.: US 2025/0001566 A1
(43) Pub. Date: Jan. 2, 2025

(54) AIR HAMMER POWERED FUEL INJECTOR REMOVER APPARATUS

(71) Applicant: Jeffrey Del Rossa, Pittsburgh, PA (US)

(72) Inventor: Jeffrey Del Rossa, Pittsburgh, PA (US)

(21) Appl. No.: 18/754,015

(22) Filed: Jun. 25, 2024

Related U.S. Application Data
(60) Provisional application No. 63/524,200, filed on Jun. 29, 2023.

(51) Int. Cl. B25B 27/00; F02M 61/14

(52) U.S. Cl. CPC B25B 27/0035; F02M 61/14

(57) ABSTRACT

An air power assisted fuel injector remover apparatus is provided. The apparatus may have a power pull fork that includes an indent on the top side of the fork to accommodate an hammer round nose chisel, a power pull pad, which has a machined “V” grooved divot in the top side to secure the jack-screw, and a jack-screw with a pointed machined point. The pull fork may be generally planar having a generally u-shaped opening on one end and a circular opening passing through the center portion of the pull fork. The circular opening receives the Jack-screw. As the bottom of the jack screw contacts the power pull pad, inserted into the valve cover, the pull fork pulls upward on the fuel injector when the jack screw is turned. The device may be used with an air hammer chisel to release a stuck fuel injector from the cylinder head or engine block.

### CROSS REFERENCE TO RELATED APPLICATIONS

The following application is a based on and claims the priority benefit of U.S. provisional application Serial No. 63/524,200 filed Jun. 29, 2023 currently co-pending; the entire content of which is incorporated by reference.

### BACKGROUND OF THE INVENTION

An air power assisted fuel injector remover apparatus is provided. The apparatus may have a power pull fork that includes a machined indent on the top side of the fork to accommodate an air or electric powered hammer round nose chisel, a power pull pad, which has a machined “V” grooved divot (female) on the top side to secure the jack-screw, and a jack-screw with a pointed machined point (male). The pull fork may be generally planar having a generally u-shaped opening on one end and a circular opening passing through the center portion of the pull fork. The circular opening receives the Jack-screw. As the bottom of the jack screw contacts the power pull pad, inserted into the valve cover, the pull fork pulls upward on the fuel injector when the jack screw is turned. Once pressure is applied to the jack screw mated to the pad, they create tension locking the assembly to the injector. The air hammer assisted apparatus may then be used in connection with an air hammer chisel to release a stuck fuel injector from the cylinder head or engine block by striking the indented portion of the pull fork.

Devices for removing fuel injectors are known. For example, U.S. Pat. No. 6,035,506 to Bowen discloses a device for removing a fuel injector from the engine block of an internal combustion engine that comprises a support member having a cylindrical channel passing through said support member, a threaded rod that includes a first lug nut fitted onto one end of said rod in a manner that supports said first lug nut and allows the rod to turn without turning said first lug nut, said threaded rod inserted through said channel in said support member, a second lug nut screwed over and onto the other end of said rod in a manner that prevents removal of said rod from said support member, and said first lug nut provided with internal threads capable of mating with the threads provided on a fuel injector.

Further, U.S. Patent Publication No.: 20090084359 to Hines discloses an improved tool for removal of fuel injectors from the cylinder head of a diesel engine having a male threaded pulling shaft having a milled top, with a female threaded connector at the bottom for releasable connection to the male threads at the top of a typical fuel injector. A sleeve fits over the threaded pulling shaft so that the base of the sleeve rests against the cylinder head, and the top of the pulling shaft extends through the top of the sleeve. A drive nut engages the threads of the shaft and can be threaded down the pulling shaft until the drive nut contacts the top of the sleeve, preferably adjacent an interposed washer. An open end wrench is then used to turn the drive nut against the sleeve, thereby lifting the threaded pulling shaft relative to the sleeve and removing the injector from the cylinder head. The injector can then be unscrewed from the female threaded connector.

However, these patent documents fail to describe a fuel injector remover apparatus which is easy to remove a fuel injector from an engine. Further, these patents fail to provide for a fuel injector remover apparatus that may be assisted by an pneumatic hammer that, in combination with harmonic vibration, allows a user to easily remove the fuel injector, especially a frozen or stuck fuel injector, in a simple, safe and productive manner.

### SUMMARY OF THE INVENTION

An air power assisted fuel injector remover apparatus is provided. The apparatus may have a power pull fork that includes a machined indent on the top side of the fork to accommodate an air or electric powered hammer round nose chisel, a power pull pad, which has a machined “V” grooved divot (female) on the top side to secure the jack-screw, and a jack-screw with a pointed machined point (male). The pull fork may be generally planar having a generally u-shaped opening on one end and a circular opening passing through the center portion of the pull fork. The circular opening receives the Jack-screw. As the bottom of the jack screw contacts the power pull pad, inserted into the valve cover, the pull fork pulls upward on the fuel injector when the jack screw is turned. The air hammer assisted apparatus may then be used in connection with an air hammer chisel to release a stuck fuel injector from the cylinder head or engine block by striking the indented portion of the pull fork.

An advantage of the present air hammer assisted fuel injector remover apparatus is that the present fuel injector remover does not need to be bolted to the cylinder head to be used, as the power pull pad facilitates securing the injector puller to the valve cover. Moreover, the present device utilizes the harmonic vibration of a power pull fork, which when struck by an air hammer chisel, the fork pivots at the pad, allowing for a vertical and horizontal vibration forces to safely and effectively remove a fuel injector from an engine or cylinder head in a quick and productive manner.

Another advantage of the present fuel injector remover apparatus is that the present power pull pad may secure a jack screw having mating female and male components that lock the pad and jack screw assembly together and secures it in the valve cover. This locking feature allows direct perpendicular forces to be applied by both the jack screw and the air hammer chisel putting the assembly in tension. Under the harmonic vibration caused by the air hammer, a direct vertical pulling force is applied to the pull fork and prevents the power pull fork from moving away from the fuel injector. Further, the present device may save a substantial amount of time from other removal processes as a result of not requiring the tedious task of fastening the apparatus to the cylinder head only to unfasten the device to remove the injector.

Still another advantage of the present fuel injector remover apparatus is that the present device is lightweight, machined from heat treated and hardened carbon steel, black oxide coated for corrosion resistance and durable.

The present fuel injector remover may also have an additional accessory which incorporates a unique stationary slide hammer that attaches directly to the fuel inlet side of the injector. The stationary slide hammer may incorporate the machined indents or divots identical to the proposed air hammer powered fork. The recessed divots provide an anchor to secure an air hammer chisel enabling harmonic vibration to assist in loosening the injector and using the vertical forces applied to break the injector free.

For a more complete understanding of the above listed features and advantages of the fuel injector remover apparatus reference should be made to the detailed description and the drawings. Further, additional features and advantages of the invention are described in, and will be apparent from, the detailed description of the preferred embodiments.

### BRIEF DESCRIPTION OF THE DRAWINGS

FIG. 1 illustrates a side view of the fuel injector remover.

FIG. 2 illustrates a perspective view of the fuel injector remover.

FIG. 3 illustrates a side view of the jack-screw of the remover.

FIG. 4 illustrates a perspective view of the jack-screw of the device.

FIG. 5 illustrates a side view of the power pull pad of the device.

FIG. 6 illustrates a perspective view of the power pull pad of the device.

FIG. 7 illustrates a cross-sectional view of the power pull pad of the device.

FIG. 8 illustrates a bottom view of the power pull pad of the device.

FIG. 9 illustrates a perspective view of the power pull fork of the device.

FIG. 10 illustrates a perspective view of the power pull fork of the device.

FIG. 11 illustrates a top view of the power pull fork of the device.

FIG. 12 illustrates another top view of the power pull fork of the device.

FIG. 13 illustrates a side view of the power pull fork of the device.

FIG. 14 illustrates a top view of the top of the jack-screw of the device.

FIG. 15 illustrates the present apparatus in the process of getting ready to be used on a fuel injector stuck in an engine block.

FIG. 16 is view of the jack-screw being inserted into the power pull pad.

FIG. 17 is a view of the device in use attached to a fuel injector.

### DETAILED DESCRIPTION OF THE PREFERRED EMBODIMENTS

An air power assisted fuel injector remover apparatus is provided. The apparatus may have a power pull fork (10) that includes a machined indented portion (325) on the top side of the fork to accommodate an air or electric powered hammer round nose chisel, a power pull pad (50), which has a machined “V” grooved divot (450) (female) in the top side to secure the jack-screw, and a jack-screw (100) with a machined point (male). The pull fork (10) may be generally planar having a generally u-shaped opening (18) on one end and a circular opening (25) passing through the center portion of the pull fork (10). The circular opening (25) receives the Jack-screw. As the bottom of the jack-screw (100) contacts the power pull pad (50) inserted into the valve cover, the pull fork (10) pulls upward on the fuel injector when the jack-screw is turned clockwise. The air hammer assisted apparatus may be used in connection with an air hammer chisel to release a stuck fuel injector from the cylinder head or engine block by striking the indented portion of the pull fork.

Referring now to the figures, in an embodiment, a fuel injector remover apparatus 1 is provided. The fuel injector remover apparatus 1 may have a power pull fork 10, a power pad 70 and a pointed screw-jack 100. The apparatus 1 is especially suitable for removing a fuel injector 200 (FIG. 17) from a cylinder head of an engine block 250.

It is not uncommon for fuel injectors 200 to get stuck in a cylinder head block 251. When the fuel injector 200 fails and is stuck in the cylinder head block 251, it becomes necessary to remove the fuel injector 200 from the cylinder head 251 or engine block 250. The present apparatus 1 helps in the removal of the fuel injector 200 from the cylinder head 251 and block 250.

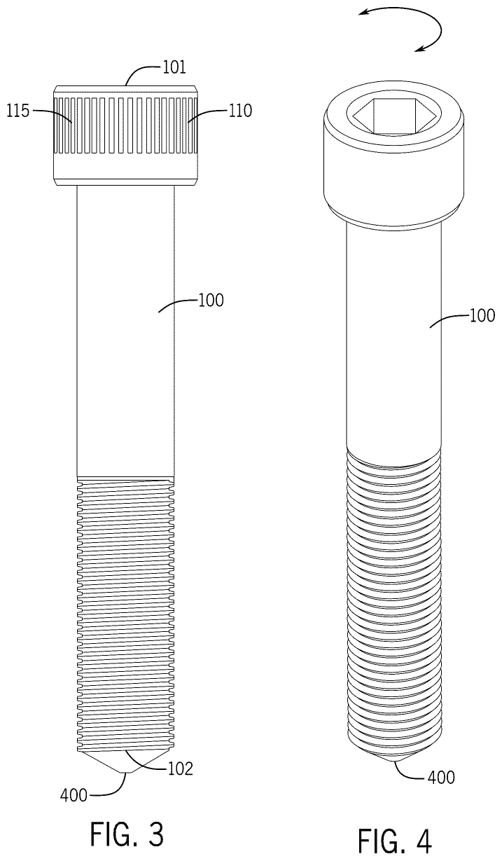

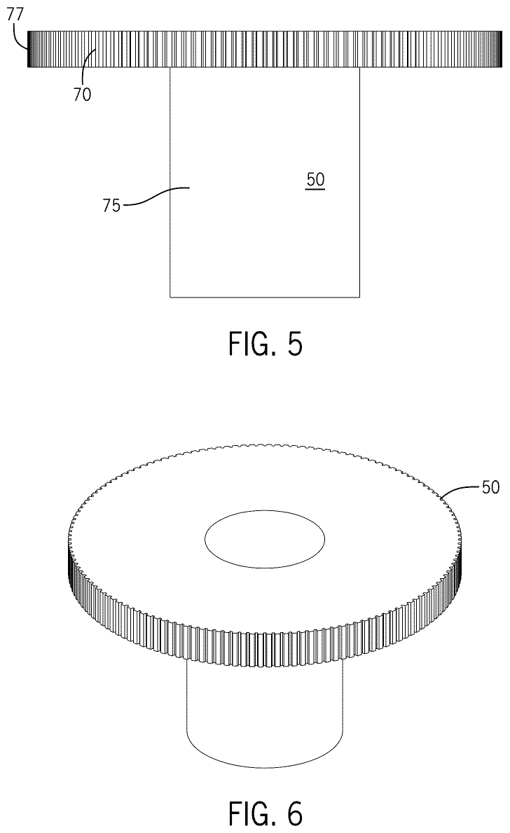

In an embodiment, the screw 100 may have a top, a bottom 400 and a generally cylindrical shaft 103. Preferably, the screw 100 is made of a durable and non-corrosive metal. A portion of the shaft 103 of the screw 100 may have a threaded member 105 which may correspondingly mate with a threaded member 25 of the power pull fork 10 (as discussed below). In the preferred embodiment, the bottom 400 of the screw 100 is cone-shaped, forming a point (as shown in FIGS. 3 and 4) for better gripping of the device.

At the top of the screw 100 may be a head portion 101. The head portion 101 may have, for example, a socket head, or slotted opening 106 for screw driver, Allen wrench 360 or some other means to rotate the screw 100. The figures illustrate an opening 106 for receiving an Allen wrench 360; however, alternative tools may be used to rotate the screw 100 as described below. In an embodiment, a side 110 of the head portion 101 of the screw 100 may further have a knurled edge 115 so as a user may better grasp the jack-screw 100 at the side 110 of the head portion 101, if necessary.

As stated above, the device, method and system 1 may have a power pull fork unit 10. The power pull fork unit 10 may have a top 11, a bottom 12, a front 13, a back 14, a first side 15 and a second side 16. The front 13 of the power pull fork 10 may have a u-shaped opening 18 for receiving a portion of the shaft of the fuel injector 200, as described below. The u-shaped opening 18 has a width 19 which is substantially equal to or slightly larger than a width of the fuel injector 200 shaft.

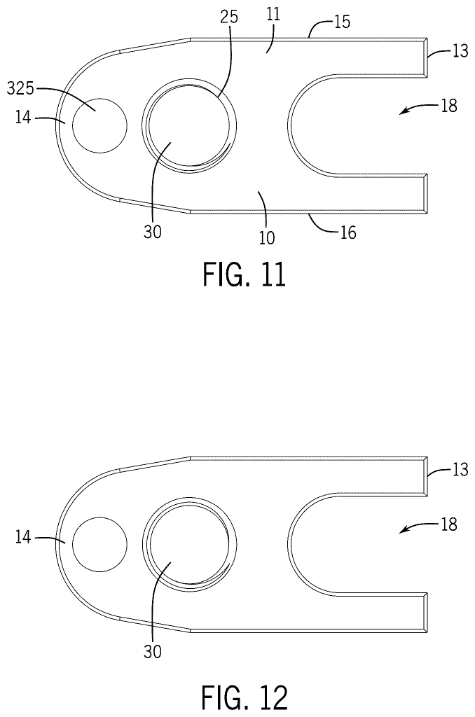

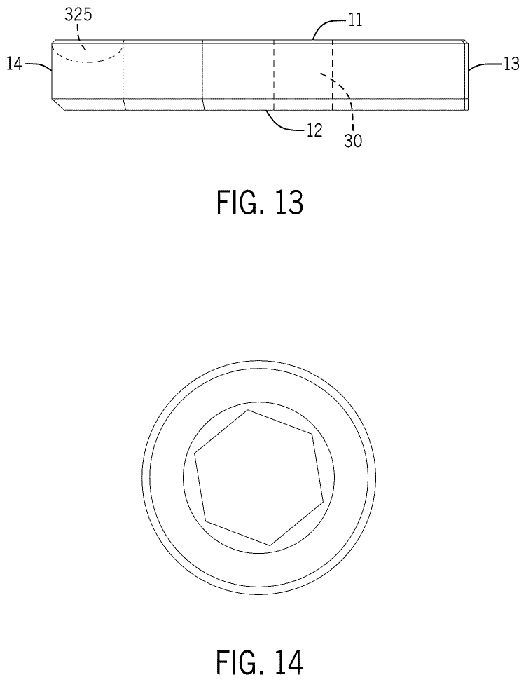

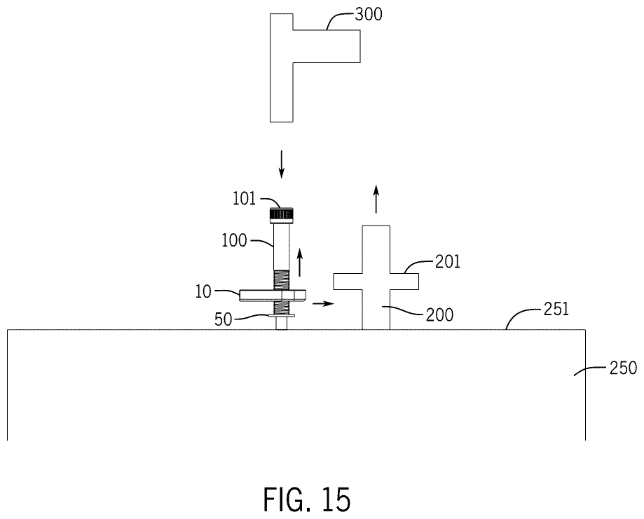

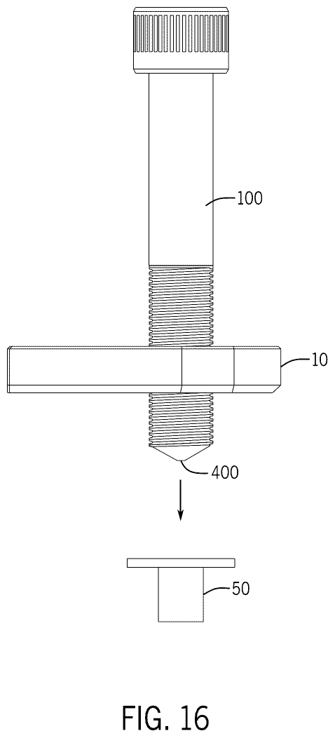

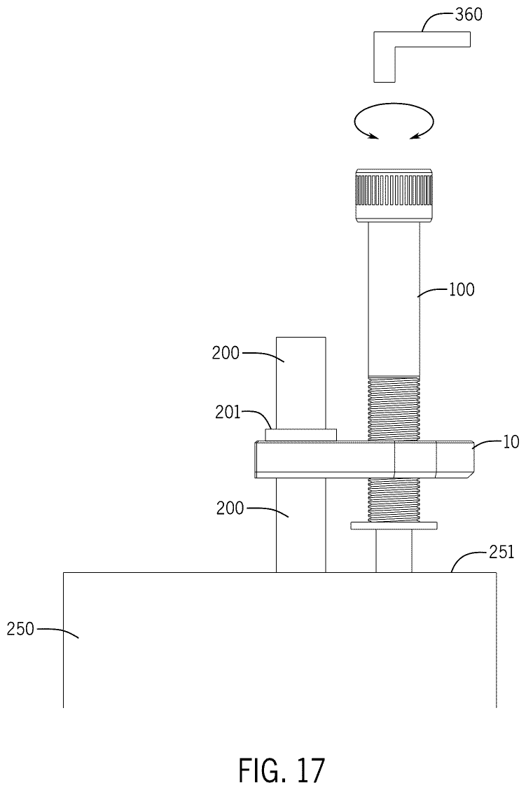

In an embodiment, the power pull fork 10 may have an indented portion 325 (as shown in FIG. 11) on the top surface 11 of the power pull fork 10. The indented portion 325 may be a generally circular concave portion which receives a chisel (the terminal end) of an air hammer (or other tool for striking the power pull fork) which may be used to vibrate the power pull fork 10 while the power pull fork 10 is secured to the fuel injector 200. The indent portion 325 keeps the chisel of the air hammer in place on the power pull fork 10 and therein prevents the air hammer from accidently becoming dislodged from the power pull for 10 during use. The vibration of the chisel of the air hammer may help the fuel injector 200 become removed from the engine block or cylinder 250. In one embodiment, the indented portion 325 has a depth equal to one quarter to one third the height of the power pull pad 325 (measured from the top 11 to the bottom 12 of the power pull pad 10) so as to be big enough to receive a portion of the air hammer and study enough to avoid damaging the power pull fork 10.

The back 14 of the power pull fork 10 is preferably curved; although alternative shapes may be used. The main body of the power pull fork 10 may have an opening 30 which allows an object to pass from the top 11 to the bottom 12 of the power pull fork 10. The opening 30 is preferably circular having a diameter. The interior walls of opening 30 of the power pull fork 10 may have the threaded member 25 which receives the threaded member 105 of the jack-screw 100. In particular, during use of the device 1, the screw 100 is secured through the opening 30 of the power pull fork 10 and wherein the screw 100 may rotate with respect to the power pull fork 10.

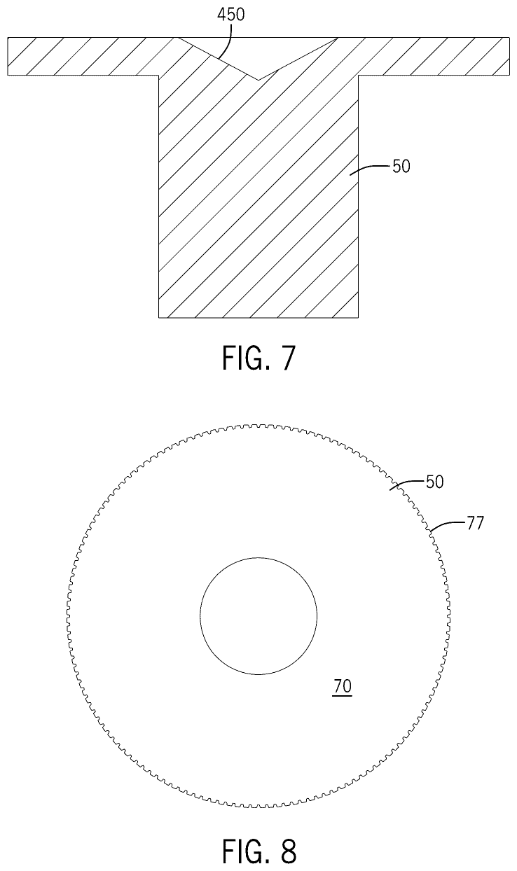

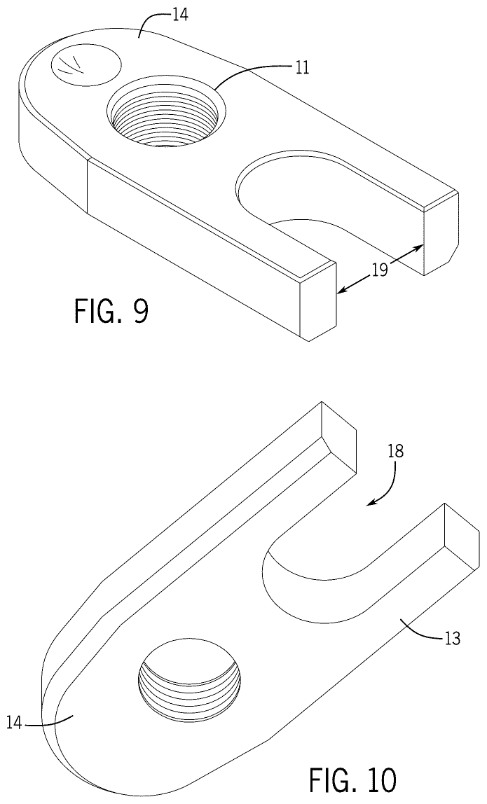

In an embodiment, the apparatus 1 may have a power pull pad 50. The power pull pad 50 may have a generally planar circular unit 70 and a shaft 75. The shaft 75 may be integrally formed with the generally planar circular unit 70. The generally planar circular unit 70 may have a knurled edge 77 and a flat bottom to rest on the top of the engine block. The power pad 50 may be secured over the bottom 400 of the screw 100. More specifically, the bottom of the screw 400 may be inserted into an inverted cone-shaped opening 450 of the power pull pad 50 as best shown in FIG. 7. When the bottom 400 of the screw 100 is inserted into the cone-shaped opening 450 of the power pull pad 50, the power pull pad 50 prevents the screw 100 from moving (or walking).

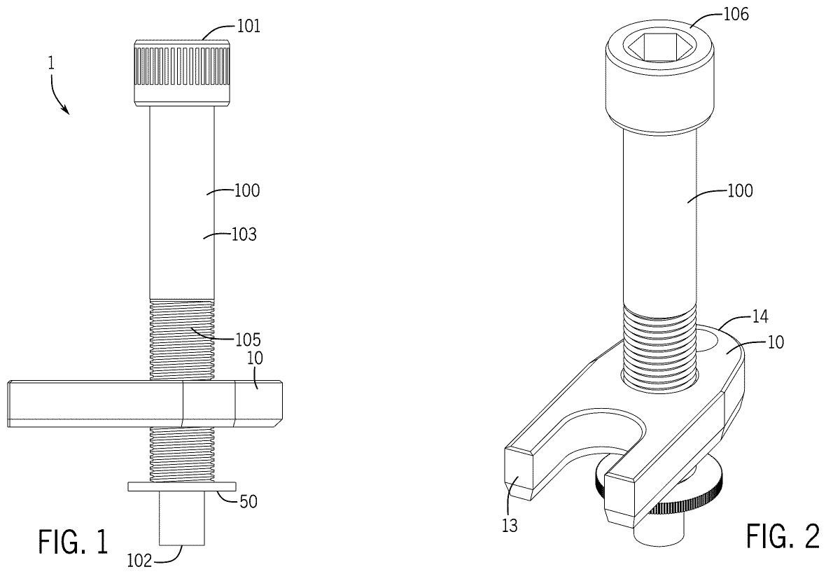

To remove the fuel injector 200 from the cylinder head or engine block 250, a user first places the u-shaped opening 18 of the power pull fork 10 under the ridge 201 of the fuel injector 200 which is attached to the cylinder block or engine block 250. The main body of the power pull fork 10 then thus straddles the fuel injector 200. The bottom 102 of the power pull pad 50 makes contact with the top of the cylinder head or engine block 250. The screw 100 is then inserted into the opening 30 of the pull fork 10 so that the pull fork 10 rests somewhere midway between the top 101 and the bottom 400 of the screw 100 as illustrated in FIG. 1. Alternatively the screw is inserted into the pull fork and then the device inserted around the fuel injector. An Allen wrench 360 is used to rotate the top (the head) 101 of the screw 100. The turning of the Allen wrench 360 turns the threads 105 of the screw and causes the power pull fork 10 to move upward (when the screw is turned the correct direction).

Pressure is then created on the underside of the ridge 201 of the fuel injector 200 by the top 11 of the pull fork 10 pulling the fuel injector 200 away from the cylinder block or engine block 250. If the turning of the Allen wrench 360 is not powerful enough to force the power pull fork 10 upward so as to force the ridge 201 of the fuel injector 200 to pull the fuel injector 200 to be released from the cylinder block or engine block 250, then an air hammer 300 may also be used to vibrate and hammer the screw 100 and pull fork 10. More specifically, a user may alternate between using the Allen wrench 360 to pull (tension) the fuel injector 200 away from the top 251 of the cylinder head or engine block 250 and using the pneumatic air hammer 300 (compression) on the power pull fork (10) at the indent/divot 325 of the pull fork 10, until the fuel injector 200 is finally released from the cylinder head or engine block 250.

Although embodiments of the invention are shown and described therein, it should be understood that various changes and modifications to the presently preferred embodiments will be apparent to those skilled in the art. Such changes and modifications may be made without departing from the spirit and scope of the invention and without diminishing its attendant advantages.

I claim:

1. A fuel injector remover apparatus comprising:
a power pull fork having a front, a back, a first side, a second side, a top and a bottom;
an opening in the power pull fork wherein the opening is circular having a diameter;
a u-shaped opening at the front of the power pull fork;
a screw having a top end, a bottom end and a generally cylindrical side;
wherein the screw passes through the opening of the power pull fork;
wherein the u-shaped opening of the power pull fork is secured around a fuel injector; and
an indented portion on the top of the power pull fork wherein the indented portion receives a portion of a tool for striking the top of the power pull fork.

2. The fuel injector remover apparatus of claim 1 further comprising:
a head of the screw at the top end of the screw wherein the head of the screw has an opening for receiving a tool to turn the screw.

3. The fuel injector remover apparatus of claim 1 further comprising:
a pointed tip of the bottom end of the screw.

4. The fuel injector remover apparatus of claim 1 further comprising:
a power pull pad having a top, a bottom and a side wherein the top of the power pull pad has an indented portion for receiving the bottom end of the screw.

5. The fuel injector remover apparatus of claim 1 further comprising:
a threaded member located within the interior of the opening of the power pull fork wherein the threaded member of the opening correspondingly mates with a threaded member of the side of the screw.

6. The fuel injector remover apparatus of claim 1 wherein the indented portion of the power pull fork has a depth between one quarter to one third of the height of the power pull fork.

7. The fuel injector remover apparatus of claim 1 wherein the power pull pad has a flat bottom and a knurled edge.

8. The fuel injector remover apparatus of claim 1 wherein the u-shaped opening has a width which is equal to or larger than a width of the fuel injector.

9. A system for removing a stuck fuel injector comprising the steps of:
providing a power pull fork having a front, a back, a first side, a second side, a top and a bottom;
providing an opening in the power pull fork wherein the opening is circular having a diameter;
providing a u-shaped opening at the front of the power pull fork;
providing a screw having a top end, a bottom end and a generally cylindrical side;
wherein the screw passes through the opening of the power pull fork;
wherein the u-shaped opening of the power pull fork is secured around a fuel injector;
providing an indented portion on the top of the power pull fork wherein the indented portion receives a portion of a tool for striking the top of the power pull fork;
placing a portion of a tool within the indented portion of the top of the power pull fork; and
striking the top of the power pull fork with the tool so transmit a force to the fuel injector to dislodge the fuel injector from an engine.
